(19) United States
(12) Patent Application Publication
(10) Pub. No.: US 2025/0162110 A1
(43) Pub. Date: May 22, 2025

(54) TOOTHED STRUCTURE

(71) Applicant: KABO TOOL COMPANY, Taichung City (TW)

(72) Inventor: Chih-Ching HSIEH, Taichung City (TW)

(21) Appl. No.: 18/925,769

(22) Filed: Oct. 24, 2024

(30) Foreign Application Priority Data
Nov. 20, 2023 (TW) 112144763

(51) Int. Cl. F16D 41/12; B25B 13/46

(52) U.S. Cl. CPC B25B 13/46

(57) ABSTRACT

A toothed structure includes a body, two tooth parts and two recessed spaces. The body includes an inner surface and an outer surface, wherein the inner surface is disposed relatively to the outer surface. The two tooth parts are disposed on two ends of the inner surface. The two recessed spaces are disposed on the body, and corresponding to the two tooth parts, respectively.

### RELATED APPLICATIONS

This application claims priority to Taiwan Application Serial Number 112144763, filed Nov. 20, 2023, which is herein incorporated by reference.

### BACKGROUND

### Technical Field

The present disclosure relates to a toothed structure. More particularly, the present disclosure relates to a toothed structure of the ratchet wrench.

### Description of Related Art

During use, if excessive force is applied with ratchet wrench, it may exceed the pressure range that the toothed structure can withstand and causing the toothed structure to be damaged. Thus, it will cause the toothed structure to be unable to engage with the ratchet, which would significantly impact the lifespan of the ratchet wrench.

In view of this, designing a toothed structure that can avoid damage due to excessive force has become an important issue faced by relevant industry in the design of ratchet wrench.

### SUMMARY

According to one aspect of the present disclosure, a toothed structure includes a body, two tooth parts and two recessed spaces. The body includes an inner surface and an outer surface, wherein the inner surface is disposed relatively to the outer surface. The two tooth parts are disposed on two ends of the inner surface. The two recessed spaces are disposed on the body, and corresponding to the two tooth parts, respectively.

According to another aspect of the present disclosure, a toothed structure includes a body, two tooth parts and four grooves. The body includes an inner surface, an outer surface and two side surfaces, wherein the inner surface is disposed relatively to the outer surface, and the two side surfaces are disposed relatively and connected between the inner surface and the outer surface. The two tooth parts are disposed at interval on the inner surface of the body. The four grooves are disposed at interval on the body, wherein each of the four grooves corresponds to one of the two tooth parts, two of the four grooves are recessed in one of the two side surfaces, and the other two of the four grooves are recessed in the other one of the two side surfaces.

According to another aspect of the present disclosure, a toothed structure includes a body, two tooth parts and four grooves. The body includes an inner surface, an outer surface and two side surfaces, wherein the inner surface is disposed relatively to the outer surface, and the two side surfaces are disposed relatively and connected between the inner surface and the outer surface. The two tooth parts are disposed at interval on the inner surface of the body. The four grooves are disposed at interval on the body, wherein each of the four grooves corresponds to one of the two tooth parts, two of the four grooves are recessed in one of the two side surfaces, and the other two of the four grooves are recessed in the other one of the two side surfaces. A reference line is defined from the one of the two tooth parts toward the outer surface, each of the four grooves has a groove thickness along the reference line, a tooth wall thickness is provided between the one of the two tooth parts and the one of the four grooves along the reference line, and the groove thickness is greater than the tooth wall thickness.

### BRIEF DESCRIPTION OF THE DRAWINGS

The present disclosure can be more fully understood by reading the following detailed description of the embodiment, with reference made to the accompanying drawings as follows:

FIG. 1 is a three dimensional view of a toothed structure of the 1st embodiment of the present disclosure.

FIG. 2 is a front view of the toothed structure of FIG. 1.

FIG. 3 is a front view of a toothed structure of the 2nd embodiment of the present disclosure.

FIG. 4 is a front view of a toothed structure of the 3rd embodiment of the present disclosure.

FIG. 5 is a front view of a toothed structure of the 4th embodiment of the present disclosure.

FIG. 6 is a three dimensional view of a toothed structure of the 5th embodiment of the present disclosure.

FIG. 7 is a cross-sectional view of the toothed structure along line 7-7 in FIG. 6.

FIG. 8 is a front view of the toothed structure of FIG. 6.

FIG. 9 is a three dimensional view of a toothed structure of the 6th embodiment of the present disclosure.

FIG. 10 is a cross-sectional view of the toothed structure along line 10-10 in FIG. 9.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

In addition, the terms first, second, third, etc. are used herein to describe various elements or components, these elements or components should not be limited by these terms. Consequently, a first element or component discussed below could be termed a second element or component.

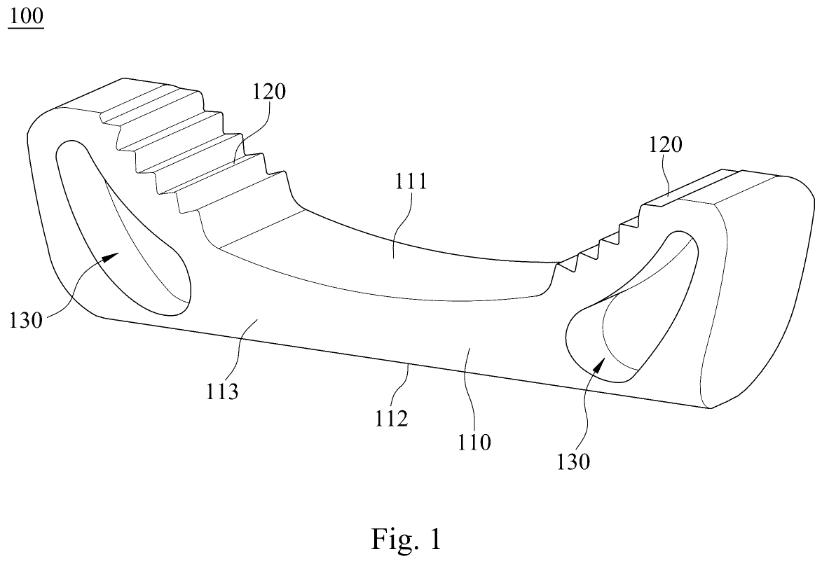

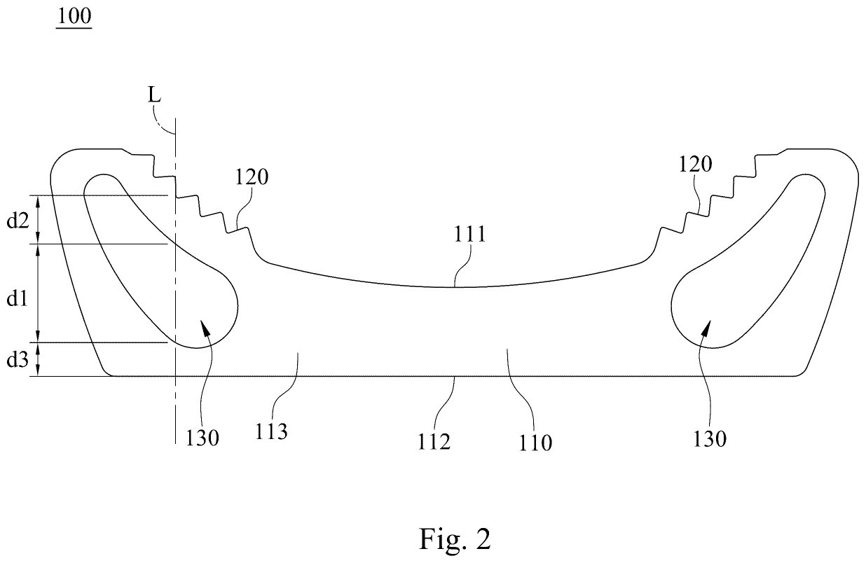

FIG. 1 is a three dimensional view of a toothed structure 100 of the 1st embodiment of the present disclosure. FIG. 2 is a front view of the toothed structure 100 of FIG. 1. According to FIG. 1 and FIG. 2, the toothed structure 100 includes a body 110, two tooth parts 120 and two recessed spaces 130, the two tooth parts 120 and the two recessed spaces 130 are disposed on the body 110. In the 1st embodiment, the toothed structure 100 can be applied to the ratchet wrench for engaging with the ratchet, the toothed structure 100 is integrally made, but the present disclosure is not limited thereto.

The body 110 includes an inner surface 111, an outer surface 112 and two side surfaces 113. The inner surface 111 is disposed relatively to the outer surface 112, the two side surfaces 113 are disposed relatively to each other, and the two side surfaces 113 are connected between the inner surface 111 and the outer surface 112. A thickness of each of two ends of the body 110 is greater than a thickness of a center of the body 110, and the two tooth parts 120 are disposed at interval on two ends of the inner surface 111. In the 1st embodiment, the inner surface 111 is a concave arc surface, the outer surface 112 is a planar surface, and each side surfaces 113 is a planar surface.

The two recessed spaces 130 are opened on one of the two side surfaces 113, the two recessed spaces 130 are located at the two ends of the body 110 and corresponding to the two tooth parts 120, respectively. The two recessed spaces 130 extend from one of the two side surfaces 113 to the other one of the two side surfaces 113, and each recessed spaces 130 can be a groove or a through hole, but the present disclosure is not limited thereto. In the 1st embodiment, the shape of each recessed spaces 130 is about a drop-shaped tapering from the outer surface 112 to the inner surface 111.

As shown in FIG. 2, a reference line L is defined from the two tooth parts 120 toward the outer surface 112, respectively. Each recessed spaces 130 has a recessed space thickness d1 along the reference line L. A tooth wall thickness d2 is provided between each tooth parts 120 and each recessed spaces 130 along the reference line L. A wall thickness d3 is provided between each recessed spaces 130 and the outer surface 112 along the reference line L. The recessed space thickness d1 is greater than the tooth wall thickness d2, and the recessed space thickness d1 is greater than the wall thickness d3.

Hence, a space of the toothed structure for compressing and deforming during the use of the ratchet wrench can be reserved so as to avoid the damage to the body 110 or the tooth parts 120, and it is favorable for improving the durability and the lifespan of the ratchet wrench.

It should be noted that, if the recessed space thickness d1 of each recessed space 130 is too small, or the tooth wall thickness d2 is too large (that is, the position of each recessed space 130 is too far from the inner surface 111) the compressing effect of the body 110 cannot be provided effectively, so that the damage of the toothed structure 100 cannot be avoided, and the durability and the lifespan of the toothed structure 100 also cannot be improved.

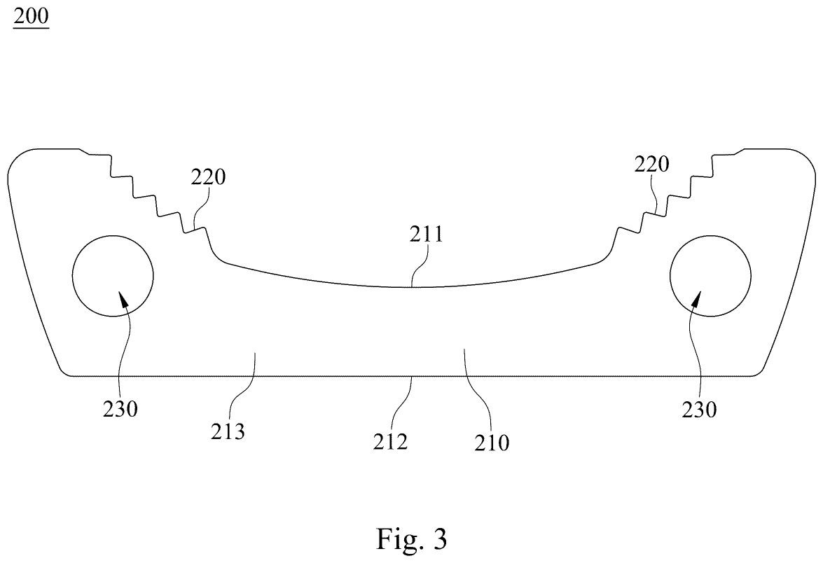

FIG. 3 is a front view of a toothed structure 200 of the 2nd embodiment of the present disclosure. According to FIG. 3, the toothed structure 200 includes a body 210, two tooth parts 220 and two recessed spaces 230. The difference between the toothed structure 200 of the 2nd embodiment and the toothed structure 100 of the 1st embodiment is the shape of the recessed spaces 230. In detail, each recessed spaces 230 is in a round shaped, and each recessed spaces 230 can be a groove or a through hole.

The body 210 includes an inner surface 211, an outer surface 212 and two side surfaces 213. The connection between the inner surface 211, the outer surface 212 and the two side surfaces 213 is the same as the connection between the inner surface 111, the outer surface 112 and the two side surfaces 113 of the 1st embodiment, the two tooth parts 220 is the same as the two tooth parts 120 of the 1st embodiment, and are not described again herein.

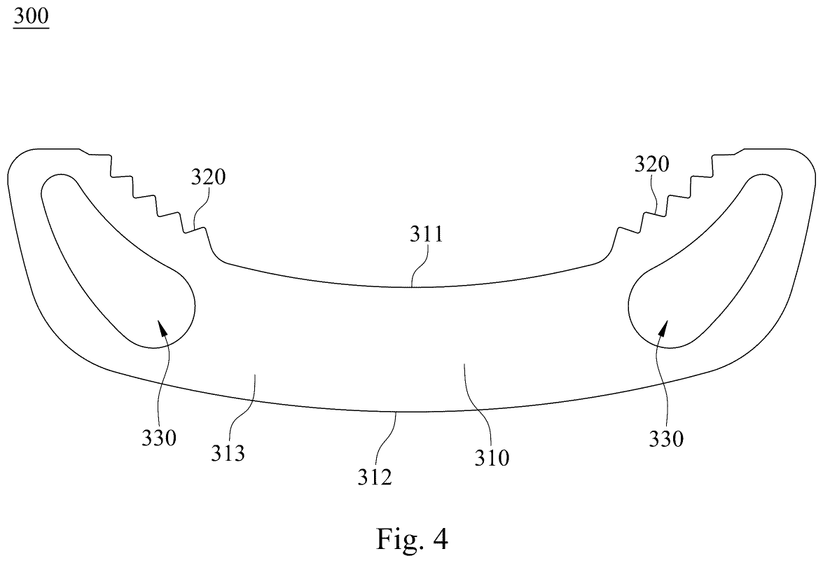

FIG. 4 is a front view of a toothed structure 300 of the 3rd embodiment of the present disclosure. According to FIG. 4, the toothed structure 300 includes a body 310, two tooth parts 320 and two recessed spaces 330. The difference between the toothed structure 300 of the 3rd embodiment and the toothed structure 100 of the 1st embodiment is the shape of the body 310.

In detail, the body 310 includes an inner surface 311, an outer surface 312 and two side surfaces 313. In the 3rd embodiment, the outer surface 312 is a convex arc surface. The connection between the inner surface 311, the outer surface 312 and the two side surfaces 313 is the same as the connection between the inner surface 111, the outer surface 112 and the two side surfaces 113 of the 1st embodiment, the two tooth parts 320 is the same as the two tooth parts 120 of the 1st embodiment, and are not described again herein. The shape of each recessed spaces 330 is the same as the shape of each recessed spaces 130 of the 1st embodiment, and each recessed spaces 330 can be a groove or a through hole, but the present disclosure is not limited thereto.

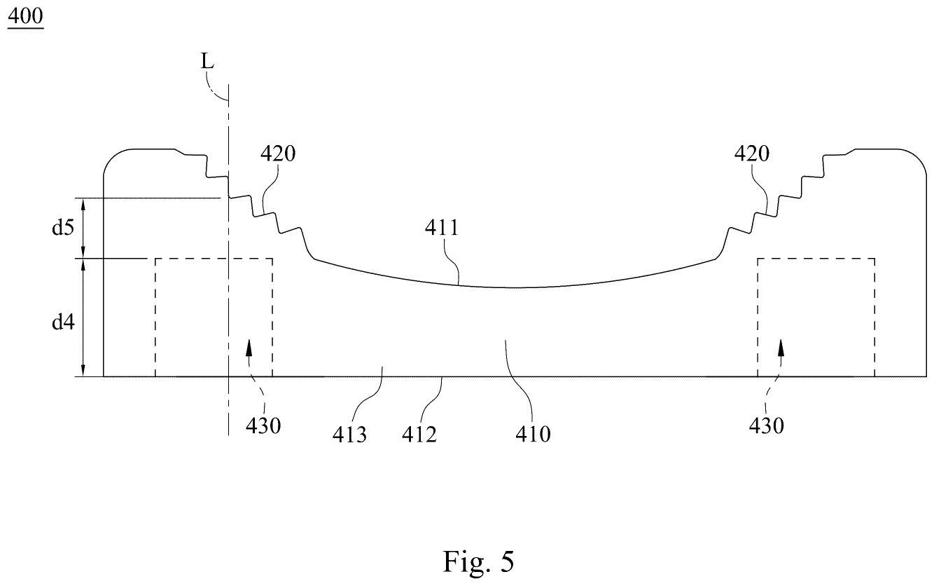

FIG. 5 is a front view of a toothed structure 400 of the 4th embodiment of the present disclosure. According to FIG. 5, the toothed structure 400 includes a body 410, two tooth parts 420 and two recessed spaces 430, the two tooth parts 420 and the two recessed spaces 430 are disposed on the body 410. In the 4th embodiment, the toothed structure 400 can be applied to the ratchet wrench for engaging with the ratchet, the toothed structure 400 is integrally made, but the present disclosure is not limited thereto.

The body 410 includes an inner surface 411, an outer surface 412 and two side surfaces 413, the two side surfaces 413 are connected between the inner surface 411 and the outer surface 412. The two tooth parts 420 are disposed at interval on two ends of the inner surface 411. The two recessed spaces 430 are opened on the outer surface 412, and each recessed spaces 430 extends from the outer surface 412 to the inner surface 411 and form a groove in the body 410.

As shown in FIG. 5, a reference line L is defined from the two tooth parts 420 toward the outer surface 412, respectively, a center of each recessed spaces 430 is not aligned with the reference line L. A recessed space thickness d4 is provided between each recessed spaces 430 and the outer surface 412 along the reference line L. A tooth wall thickness d5 is provided between each tooth parts 420 and each recessed spaces 430 along the reference line L. The recessed space thickness d4 is greater than the tooth wall thickness d5.

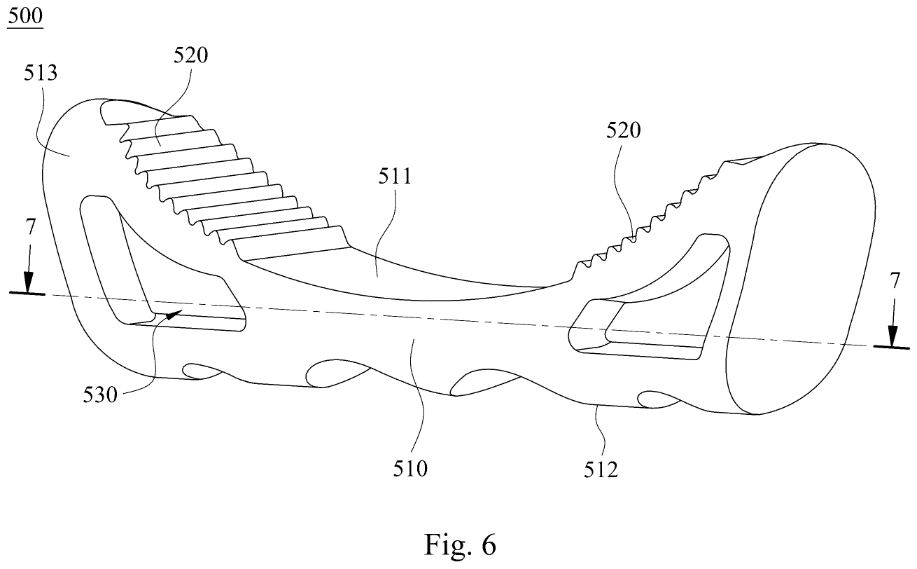

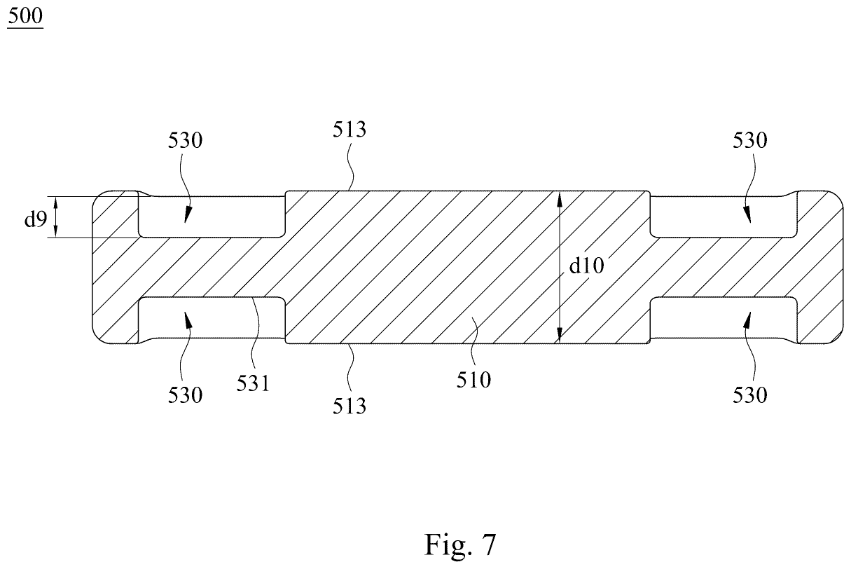

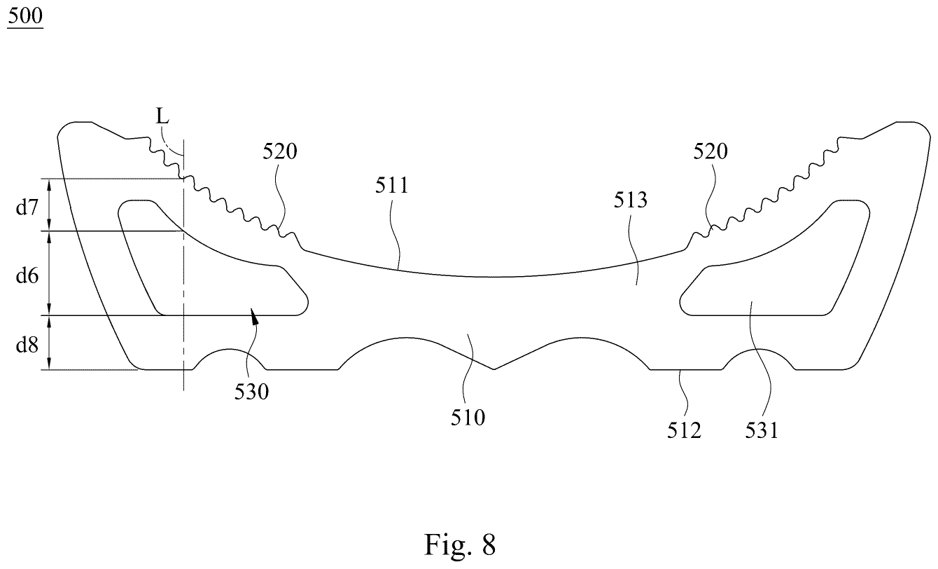

FIG. 6 is a three dimensional view of a toothed structure 500 of the 5th embodiment of the present disclosure. FIG. 7 is a cross-sectional view of the toothed structure 500 along line 7-7 in FIG. 6. FIG. 8 is a front view of the toothed structure 500 of FIG. 6. According to FIG. 6 to FIG. 8, the toothed structure 500 includes a body 510, two tooth parts 520 and four grooves 530. In the 5th embodiment, the toothed structure 500 can be applied to the ratchet wrench for engaging with the ratchet, the toothed structure 500 is integrally made, but the present disclosure is not limited thereto.

The body 510 includes an inner surface 511, an outer surface 512 and two side surfaces 513. The inner surface 511 is disposed relatively to the outer surface 512, the two side surfaces 513 are disposed relatively to each other, and the two side surfaces 513 are connected between the inner surface 511 and the outer surface 512. In detail, as shown in FIG. 6, the inner surface 511 is a concave arc surface, and the distance from the inner surface 511 to the outer surface 512 gradually increases from the center of the body 510 toward the two ends of the body 510, so that the two ends of the body 510 have a greater thickness compared to the center of the body 510. Therefore, when the toothed structure 500 is applied to the ratchet wrench, the inner surface 511 of the body 510 can correspond to the shape of the ratchet, and the configuration of each ends of the body 510 with greater thickness can provide the toothed structure 500 with excellent structural strength so as to improve the durability of the toothed structure 500.

The two tooth parts 520 are disposed at interval on two ends of the inner surface 511 of the body 510. In detail, each tooth parts 520 includes a plurality of protruding teeth (its reference numeral is omitted), each of the protruding teeth is arranged side by side on the inner surface 511. The shape of the protruding teeth corresponds to the shape of the ratchet so as to provide the two tooth parts 520 of the toothed structure 500 to engage with the ratchet.

The four grooves 530 are disposed at interval on two ends of the body 510, wherein each of the four grooves 530 corresponds to one of the two tooth parts 520, two of the four grooves 530 are recessed in one of the two side surfaces 513, and the other two of the four grooves 530 are recessed in the other one of the two side surfaces 513. Hence, a space for the body 510 to deform after being stressed can be provided by the configuration of the toothed structure 500 with the four grooves 530 so as to avoid the damage to the two tooth parts 520 of the toothed structure 500 due to excessive force applied with the ratchet wrench, and it is favorable for improving the durability of the toothed structure 500. Further, the compressing effect of the body 510 after being stressed can be improved by the configuration of two of the four grooves 530 recessed in one of two side surfaces 513, and the other two of the four grooves 530 recessed in the other one of the two side surfaces 513, and it is favorable for improving the durability of the toothed structure 500. Moreover, the lubricating oil can be stored in the four grooves 530 to prevent the toothed structure 500 from being stuck with ratchet, and it is favorable for improving the lifespan of the toothed structure 500.

As shown in FIG. 7, the two of the four grooves 530 located on different side surface 513 can be arranged relatively to each other, and the other two of the four grooves 530 located on different side surface 513 can also be arranged relatively to each other. Therefore, the two of the four grooves 530 relatively to each other can simultaneously respond to the shape change of the body 510 after being stressed, and it is favorable for further improving the durability of the toothed structure 500.

Further, in the toothed structure 500, each of the four grooves 530 has a bottom surface 531, and the bottom surface 531 is a planar surface. Hence, the distance which between the two of the four grooves 530 relatively to each other is equidistantly from the center of the body 510 toward the two ends of the body 510 so as to provide the body 510 excellent compressing effect after being stressed.

As shown in FIG. 8, a reference line L is defined from one of the two tooth parts 520 toward the outer surface 512. Each of the four grooves 530 has a groove thickness d6 along the reference line L. A tooth wall thickness d7 is provided between one of the two tooth parts 520 and one of the four grooves 530 along the reference line L. A wall thickness d8 is provided between each of the four grooves 530 and the outer surface 512 along the reference line L. The groove thickness d6 is greater than the tooth wall thickness d7, and the groove thickness d6 is greater than the wall thickness d8. Hence, excellent compressing effect for the body 510 after being stressed can be provided by meeting the specific size ratio of the groove thickness d6, tooth wall thickness d7 and wall thickness d8, and it is favorable for improving the durability of the toothed structure 500.

As shown in FIG. 7 and FIG. 8, each of the four grooves 530 has a groove depth d9, the groove depth d9 is perpendicular to the reference line L, and the groove depth d9 accounts for 25% to 35% of a body thickness d10 of the body 510. Hence, increasing the internal space of the groove 530 on the premise of maintaining the necessary structural strength of the body 510 by meeting the specific range of the groove depth d9, and it is favorable for improving the effect of the four grooves 530 which is in response to the compression and deformation of the body 510 so as to improve the durability of the toothed structure 500.

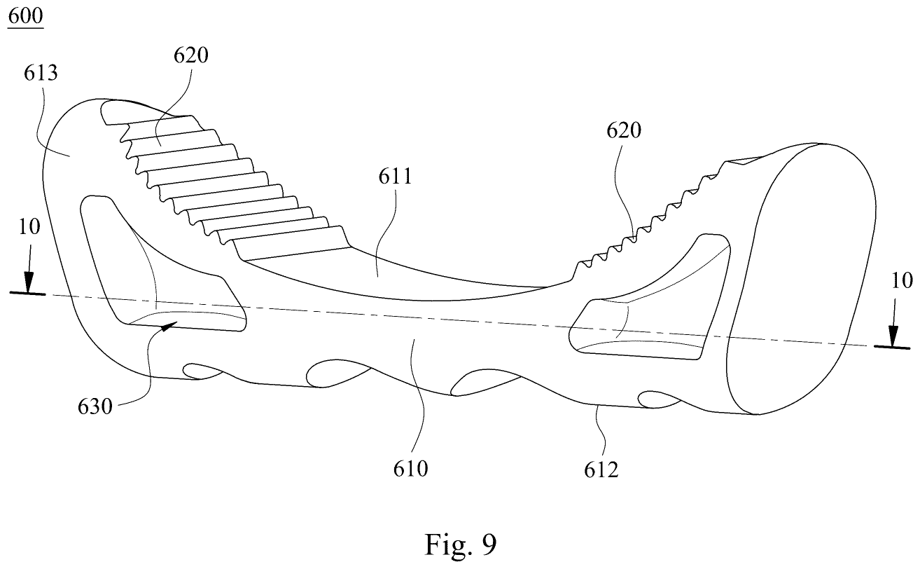

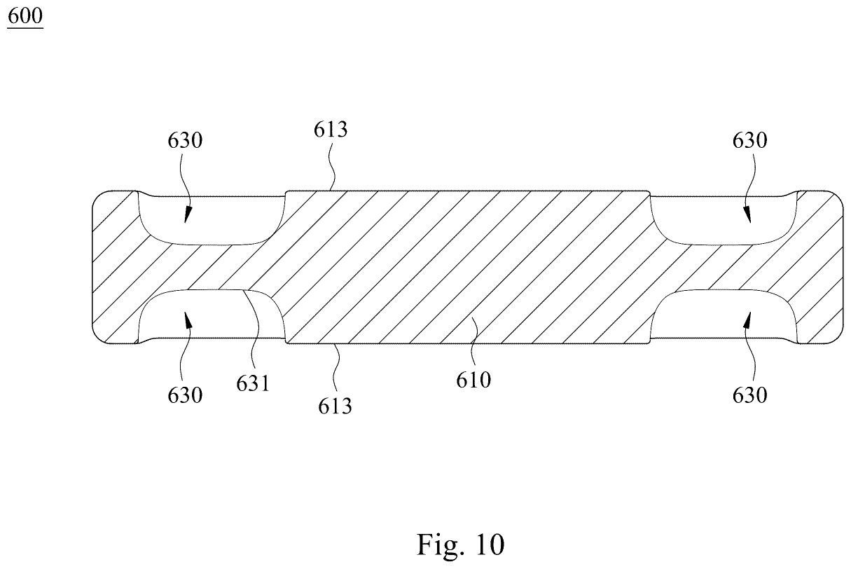

FIG. 9 is a three dimensional view of a toothed structure 600 of the 6th embodiment of the present disclosure. FIG. 10 is a cross-sectional view of the toothed structure 600 along line 10-10 in FIG. 9. According to FIG. 9 to FIG. 10, the toothed structure 600 includes a body 610, two tooth parts 620 and four grooves 630. The difference between the toothed structure 600 of the 6th embodiment and the toothed structure 500 of the 5th embodiment is the shape of the bottom surface 631 of the four grooves 630. In detail, each of the bottom surface 631 of the four grooves 630 is a concave arc surface. Therefore, the manufacturing cost of toothed structure 600 can be reduced on the premise of maintaining the necessary structural strength of the body 610. Further, the four grooves 630 can store more lubricating oil by the configuration of the bottom surface 631 of the four grooves 630 in concave arc surface, and it is favorable for improving the usability of the toothed structure 600.

The body 610 includes an inner surface 611, an outer surface 612 and two side surfaces 613. The connection between the inner surface 611, the outer surface 612 and the two side surfaces 613 is the same as the connection between the inner surface 511, the outer surface 512 and the two side surfaces 513 of the 5th embodiment, the two tooth parts 620 and the four grooves 630 are the same as the two tooth parts 520 and the four grooves 530 of the 5th embodiment, and are not described again herein.

In view of the above, the toothed structure of the present disclosure has the following advantages. First, the space of the toothed structure for compressing and deforming during the use of the ratchet wrench can be reserved by the configuration of the recessed space so as to avoid the damage to the body due to excessive force, and it is favorable for improving the durability and the lifespan of the ratchet wrench. Second, the compressing effect of the body after being stressed can be improved by the configuration of two of the four grooves recessed in one of two side surfaces, and the other two of the four grooves recessed in the other one of two side surfaces, and it is favorable for avoiding the damage to the tooth parts of the toothed structure due to excessive force of the ratchet wrench. Further, the lubricating oil can be stored in the grooves of the toothed structure so as to prevent the problem that the ratchet wrench cannot be used normally due to rust and jamming between the ratchet and the toothed structure. Third, excellent compressing effect for the body after being stressed can be provided by meeting the specific size ratio of the groove thickness, tooth wall thickness and wall thickness, and it is favorable for improving the durability of the toothed structure. Fourth, the lifespan of the toothed structure can be improved by meeting the specific range of the groove depth. Therefore, the toothed structure of the present disclosure has the potential of commercial application in relevant industry.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A toothed structure, comprising:
a body comprising an inner surface and an outer surface, wherein the inner surface is disposed relatively to the outer surface;
two tooth parts disposed on two ends of the inner surface; and
two recessed spaces disposed on the body, and corresponding to the two tooth parts, respectively.

2. The toothed structure of claim 1, wherein,
a reference line is defined from the two tooth parts toward the outer surface, respectively, each of the two recessed spaces has a recessed space thickness along the reference line, and a tooth wall thickness is provided between each of the two tooth parts and each of the two recessed spaces along the reference line;
the recessed space thickness is greater than the tooth wall thickness.

3. The toothed structure of claim 2, wherein,
a wall thickness is provided between each of the two recessed spaces and the outer surface along the reference line;
the recessed space thickness is greater than the wall thickness.

4. The toothed structure of claim 1, wherein the body further comprises:
two side surfaces connected between the inner surface and the outer surface;
wherein, the two recessed spaces are opened on one of the two side surfaces and extend from the one of the two side surfaces to the other one of the two side surfaces.

5. The toothed structure of claim 1, wherein each of the two recessed spaces is a groove or a through hole.

6. The toothed structure of claim 1, wherein each of the two recessed spaces is in a round shaped or in a drop-shaped.

7. The toothed structure of claim 1, wherein the inner surface is a concave arc surface.

8. The toothed structure of claim 1, wherein the outer surface is a planar surface or a convex arc surface.

9. The toothed structure of claim 1, wherein the two recessed spaces are opened on the outer surface and extend from the outer surface to the inner surface.

10. The toothed structure of claim 9, wherein,
a reference line is defined from the two tooth parts toward the outer surface, respectively, a center of each of the two recessed spaces is not aligned with the reference line;
a recessed space thickness is provided between each of the two recessed spaces and the outer surface along the reference line, and a tooth wall thickness is provided between each of the two tooth parts and each of the two recessed spaces along the reference line;
the recessed space thickness is greater than the tooth wall thickness.

11. A toothed structure, comprising:
a body comprising an inner surface, an outer surface and two side surfaces, wherein the inner surface is disposed relatively to the outer surface, and the two side surfaces are disposed relatively and connected between the inner surface and the outer surface;
two tooth parts disposed at interval on the inner surface of the body; and
four grooves disposed at interval on the body, wherein each of the four grooves corresponds to one of the two tooth parts, two of the four grooves are recessed in one of the two side surfaces, and the other two of the four grooves are recessed in the other one of the two side surfaces.

12. The toothed structure of claim 11, wherein the inner surface is a concave arc surface.

13. The toothed structure of claim 11, wherein each of the four grooves has a bottom surface, and the bottom surface is a planar surface or a concave arc surface.

14. The toothed structure of claim 11, wherein a reference line is defined from the one of the two tooth parts toward the outer surface, each of the four grooves has a groove thickness along the reference line, and a wall thickness is provided between the one of the four grooves and the outer surface along the reference line, and the groove thickness is greater than the wall thickness.

15. The toothed structure of claim 14, wherein each of the four grooves has a groove depth, the groove depth is perpendicular to the reference line, and the groove depth accounts for 25% to 35% of a body thickness.

16. A toothed structure, comprising:
a body comprising an inner surface, an outer surface and two side surfaces, wherein the inner surface is disposed relatively to the outer surface, and the two side surfaces are disposed relatively and connected between the inner surface and the outer surface;
two tooth parts disposed at interval on the inner surface of the body; and
four grooves disposed at interval on the body, wherein each of the four grooves corresponds to one of the two tooth parts, two of the four grooves are recessed in one of the two side surfaces, and the other two of the four grooves are recessed in the other one of the two side surfaces;
wherein, a reference line is defined from the one of the two tooth parts toward the outer surface, each of the four grooves has a groove thickness along the reference line, a tooth wall thickness is provided between the one of the two tooth parts and each of the four grooves along the reference line, and the groove thickness is greater than the tooth wall thickness.

17. The toothed structure of claim 16, wherein the inner surface is a concave arc surface.

18. The toothed structure of claim 16, wherein a wall thickness is provided between the each of the four grooves and the outer surface along the reference line, and the groove thickness is greater than the wall thickness.

19. The toothed structure of claim 16, wherein each of the four grooves has a bottom surface, and the bottom surface is a planar surface or a concave arc surface.

20. The toothed structure of claim 16, wherein each of the four grooves has a groove depth, the groove depth is perpendicular to the reference line, and the groove depth accounts for 25% to 35% of a body thickness.
